(19) United States
(12) Patent Application Publication
(10) Pub. No.: US 2008/0179128 A1
(43) Pub. Date: Jul. 31, 2008

(54) Transaxle

(76) Inventors: Koji IWAKI, Amagasaki-shi (JP); Fumitoshi Ishino, Amagasaki-shi (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/022,642

(22) Filed: Jan. 30, 2008

(30) Foreign Application Priority Data
Jan. 30, 2007 (JP) JP2007-19991

(51) Int. Cl. B60K 17/356

(52) U.S. Cl. 180/242

(57) ABSTRACT

A transaxle comprises: a pair of left and right steerable wheels; a hydraulic pressure source; a pair of left and right variable displacement hydraulic motors, serving as first and second hydraulic motors for driving the respective steerable wheels, wherein the first and second hydraulic motors are fluidly connected in parallel to the hydraulic pressure source, and wherein the first and second hydraulic motors are provided with respective movable swash plates; and a motor control linkage for simultaneously moving both the swash plates of the first and second hydraulic motors according to a turning angle of one of the steerable wheels. The motor control linkage includes a first pivot shaft for controlling the swash plate of the first hydraulic motor, a second pivot shaft for controlling the swash plate of the second hydraulic motor, a first arm pivoted on a side of the first pivot shaft opposite to the second pivot shaft so as to be linked to the one of the steerable wheels, a second arm provided on the first pivot shaft so as to be linked to the first arm, a third arm provided on the first pivot shaft rotatably integrally with the second arm, and a fourth arm provided on the second pivot shaft, the fourth arm including a first contact portion. When the first arm rotates according to turning of the steerable wheel, the second and third arms rotate from initial positions of the second and third arms, so that the fourth arm, contacting the third arm at the first contact portion, rotates from an initial position of the fourth arm.

### BACKGROUND OF THE INVENTION

1. Field of the Invention

The present invention relates to a transaxle, including a pair of left and right steerable wheels, a pair of left and right variable displacement hydraulic motors, and a motor control linkage. The hydraulic motors are fluidly connected in parallel to a hydraulic pressure source so as to drive the respective steerable wheels. The motor control linkage is adapted to simultaneously move both swash plates of the respective hydraulic motors in response to the turn angle of the pair of steerable wheels.

2. Related Art

Conventionally, there is a well-known transaxle as described later in the present application referring to FIGS. 9 and 10. The transaxle includes a pair of left and right steerable wheels, a hydraulic pressure source, and a pair of left and right variable displacement hydraulic motors, and a motor control linkage. The pair of hydraulic motors are fluidly connected in parallel to the hydraulic pressure source so as to drive the respective steerable wheels. The motor control linkage is adapted to simultaneously move both swash plates of the respective hydraulic motors in response to the turn angle of the pair of steerable wheels.

A reference WO-A1-2004/062959 discloses a representative transaxle provided with such a motor control linkage. In the transaxle, a duct plate is interposed between left and right hydraulic motors so that cylinder blocks of the respective hydraulic motors are mounted on left and right opposite side surfaces of the duct plate. The hydraulic motors include respective movable swash plates each of which is disposed opposite to the duct plate with respect to the corresponding duct plate. The motor control linkage includes a pair of swash plate pivot shafts connected to the respective movable swash plates and projecting outward a casing of the transaxle. Both the swash plate pivot shafts are linked to one of the steerable wheels, and are linked to each other.

In the motor control linkage, the left and right hydraulic motors are provided with respective springs for returning the respective swash plate pivot shafts to respective initial positions. As each of the swash plate pivot shafts rotates, a push-pin moves together with the swash plate pivot shaft so as to push one end of the corresponding spring. Meanwhile, an initial-position-adjusting pin fixed to the casing of the transaxle or the like retains the other end of the swash plate pivot shaft. As the end of the spring pushed by the push-pin becomes distant from the other end of the spring retained by the initial-position-adjusting pin, the spring generates a biasing force for returning the swash plate pivot shaft to the initial position. Both the swash plate pivot shafts disposed at the respective initial positions define the initial positions of the respective movable swash plates, i.e., define the total initial displacement of both the hydraulic motors defining speeds of the left and right steerable wheels during straight traveling of a vehicle.

Further, each of the initial-position-adjusting pins is an eccentric pin fastened to the casing or the like by a nut. By loosening the nut and rotating the initial-position-adjusting pin, the initial position of the swash plate pivot shaft is adjusted so as to adjust the initial position of the corresponding movable swash plate, i.e., the initial displacement of the corresponding hydraulic motor.

However, in the conventional motor control linkage, an arm is pivoted on a third pivot shaft disposed between the left and right swash plate pivot shafts, and is linked to one of the steerable wheels. The third pivot shaft abuts against other arms pivoted on the respective swash plate pivot shafts so as to serve as a camshaft, which has to be formed in a complicated shape. Further, the rotatable range of the camshaft and the arm pivoted on the camshaft has to be ensured between the left and right swash plate pivot shafts. Consequently, the duct plate between the left and right hydraulic motors is required to have a large thickness in the left-and-right direction, such as to hinder the minimization, simplification and economization of the transaxle.

Further, in the conventional motor control linkage, both the hydraulic motors are provided with respective eccentric pins serving as the initial-position-adjusting pins. Since the hydraulic motors of the transaxle are fluidly connected in parallel to the hydraulic pressure source as mentioned above, the proper adjustment of the initial total displacement of the hydraulic motors essentially requires only one of the swash plates to be subjected to the initial position adjustment. However, in the conventional motor control linkage, the swash plate pivot shafts are linked to each other through the cam linked to the steerable wheel. Thus, the initial position adjustment of one swash plate pivot shaft requires the initial position adjustment of the other swash plate pivot shaft to accurately correspond to the initial position adjustment of the one swash plate pivot shaft. This is the reason why the hydraulic motors require the respective initial-position-adjusting pins requiring the complicated adjustment therebetween.

### SUMMARY OF THE INVENTION

An object of the invention is to provide a transaxle improved in compactness, simplification and economization, wherein the transaxle includes a pair of left and right steerable wheels, a hydraulic pressure source, a pair of left and right variable displacement hydraulic motors for driving the respective steerable wheels, the hydraulic motors being fluidly connected in parallel to the hydraulic pressure source and including respective movable swash plates, and a motor control linkage for simultaneously moving both the swash plates of the hydraulic motors.

To achieve the object, according to the invention, a transaxle comprises a pair of left and right steerable wheels, a hydraulic pressure source, a pair of left and right variable displacement hydraulic motors, and a motor control linkage. The pair of left and right hydraulic motors serve as first and second hydraulic motors for driving the respective steerable wheels. The first and second hydraulic motors are fluidly connected in parallel to the hydraulic pressure source, and are provided with respective movable swash plates. The motor control linkage is provided for simultaneously moving both the swash plates of the first and second hydraulic motors according to a turning angle of one of the steerable wheels. The motor control linkage includes a first pivot shaft for controlling the swash plate of the first hydraulic motor, a second pivot shaft for controlling the swash plate of the second hydraulic motor, a first arm pivoted on a side of the first pivot shaft opposite to the second pivot shaft so as to be linked to the one of the steerable wheels, a second arm provided on the first pivot shaft so as to be linked to the first arm, a third arm provided on the first pivot shaft rotatably integrally with the second arm, and a fourth arm provided on the second pivot shaft, the fourth arm including a first contact portion. When the first arm rotates according to turning of the steerable wheel, the second and third arms rotate from initial positions of the second and third arms, so that the fourth arm, contacting the third arm at the first contact portion, rotates from an initial position of the fourth arm.

Due to the structure, the first arm linked to the one of the steerable wheels is not pivoted between the first and second pivot shafts for controlling the respective movable swash plates, but it is disposed on a side of the first pivot shaft opposite to the second pivot shaft. Therefore, the first and second pivot shafts for controlling the respective swash plates are provided therebetween with neither pivot shaft nor arm to be linked to the steerable wheel or to link the first and second arms to each other, thereby enabling a duct plate disposed between the left and right hydraulic motors to be reduced in thickness and costs. The only simple structure of contacting the third and fourth arms at the first contact portion of the fourth arm ensures the linking between the first and second pivot shafts for controlling the respective swash plates, thereby compacting, simplifying and economizing the transaxle.

Preferably, the first arm includes a pair of second and third contact portions at which the first arm contacts the second arm. The second arm contacts both the second and third contact portions of the first arm when the second arm is disposed at the initial position of the second arm. When the one of the steerable wheels turns left or right, the second arm is pushed by one of the second and third contact portions of the first arm so that the rotatable direction of the second arm from the initial position of the second arm and the rotatable direction of the third arm from the initial position of the third arm are constant regardless of whether the one of the steerable wheels turns left or right.

Therefore, due to the contact of the second arm to either the second or third contact portion, the second and third arms and the fourth arm linked to the third arm as mentioned above rotate in their constant directions from their respective initial positions regardless of whether the steerable wheels turn left or right. No arm requires complicated forming of a cam surface that is required for the conventional motor control linkage. Such a simple structure ensures the simultaneous tilting of both the movable swash plates of the hydraulic motors according to left or right turning of the one of the steerable wheels.

Preferably, the transaxle further comprises an initial position adjusting means provided to one of the first and second pivot shaft so as to adjust the corresponding first or second pivot shaft.

Such a simple arrangement of the initial position adjusting means is realized because the first and second pivot shafts are linked to each other by contacting the third arm to the first contact portion of the fourth arm without a complicated structure for linking the first and second pivot shafts third and fourth arms to the steerable wheel. In this way, the adjustment of the initial position for only one of the hydraulic motors is enough to adjusting the initial total displacement of the hydraulic motors fluidly connected in parallel to the hydraulic pressure source without trouble of the linking between the first and second pivot shafts. Therefore, the transaxle is further simplified and economized, and the initial positions of the first and second pivot shafts can be easily adjusted.

These, other and further objects, features and advantages of the invention will appear more fully from the following description with reference to accompanying drawings.

### BRIEF DESCRIPTION OF THE DRAWINGS

FIG. 1 is a plan view partly in section of a transaxle according to the invention.

FIG. 2 is a sectional rear view of the transaxle.

FIG. 3 is a rear view of a principal portion of the transaxle during straight traveling of a vehicle.

FIG. 4 is a rear view of the principal portion of the transaxle during left turning of the vehicle.

FIG. 5 is a rear view of the principal portion of the transaxle during right turning of the vehicle.

FIG. 6 is a cross sectional view taken along A-A line of FIG. 3.

FIG. 7 is a rear view of the principal portion of the transaxle from which a rear cover has been removed.

FIG. 8 is a fragmentary sectional plan view of the transaxle showing a structure for supporting an engaging pin and an initial position adjusting pin.

FIG. 9 is a skeleton diagram of an engine power transmission system of a four-wheel drive vehicle equipped with the transaxle for driving front wheels.

FIG. 10 is a hydraulic circuit diagram of the vehicle of FIG. 9.

FIG. 11 is a schematic plan view of the vehicle of FIG. 9.

FIG. 12 is a schematic plan view of another four-wheel drive vehicle equipped with the transaxle for driving front wheels.

### DETAILED DESCRIPTION OF THE INVENTION

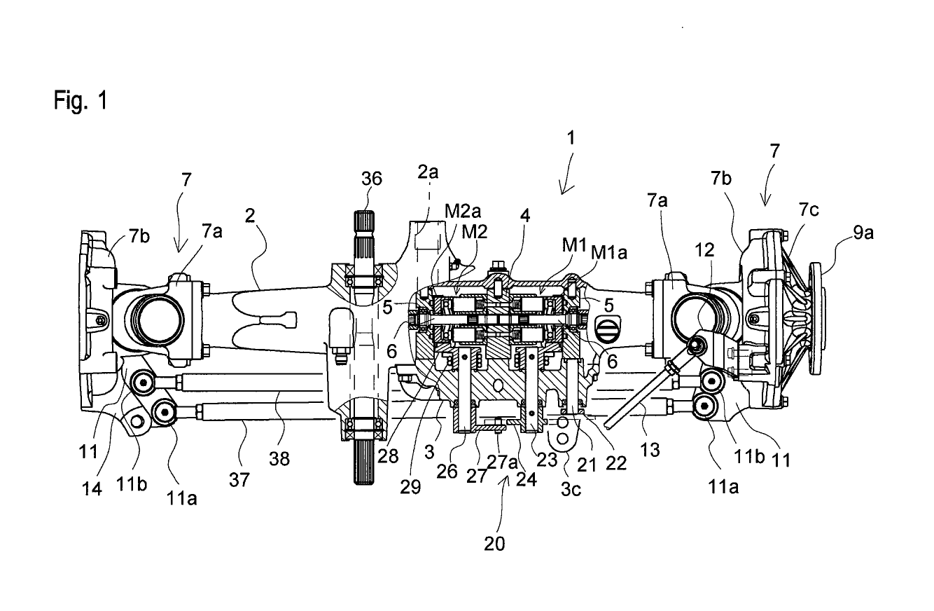

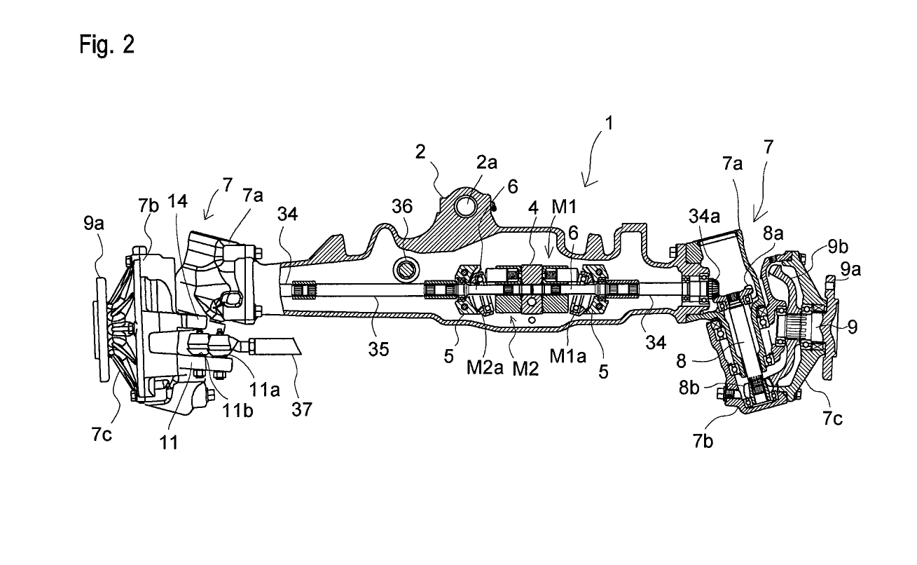

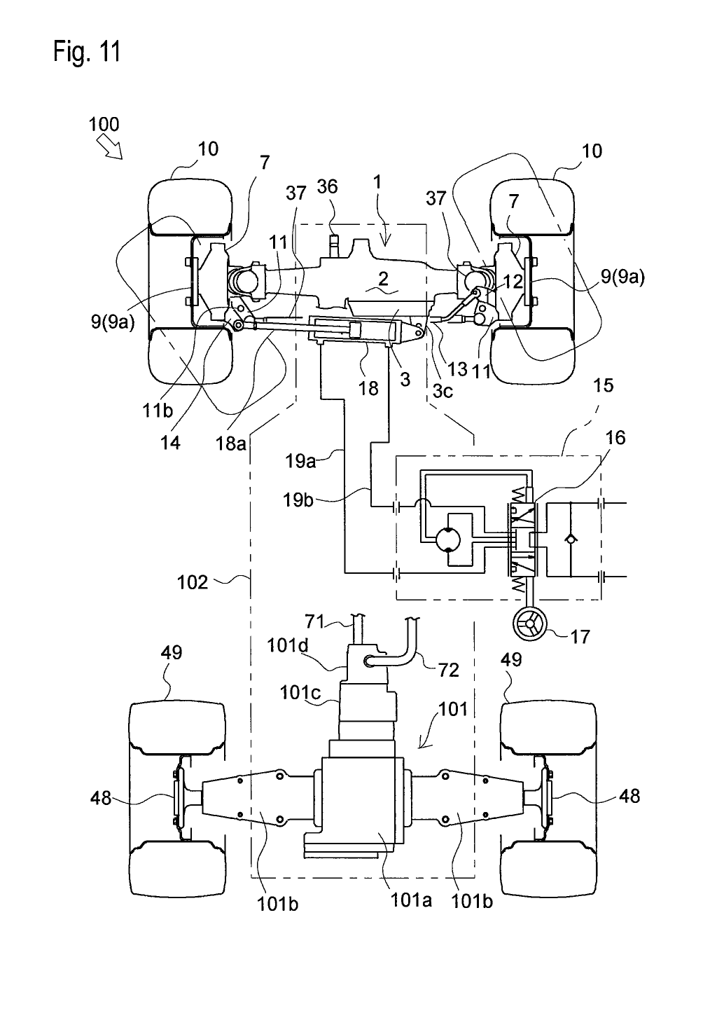

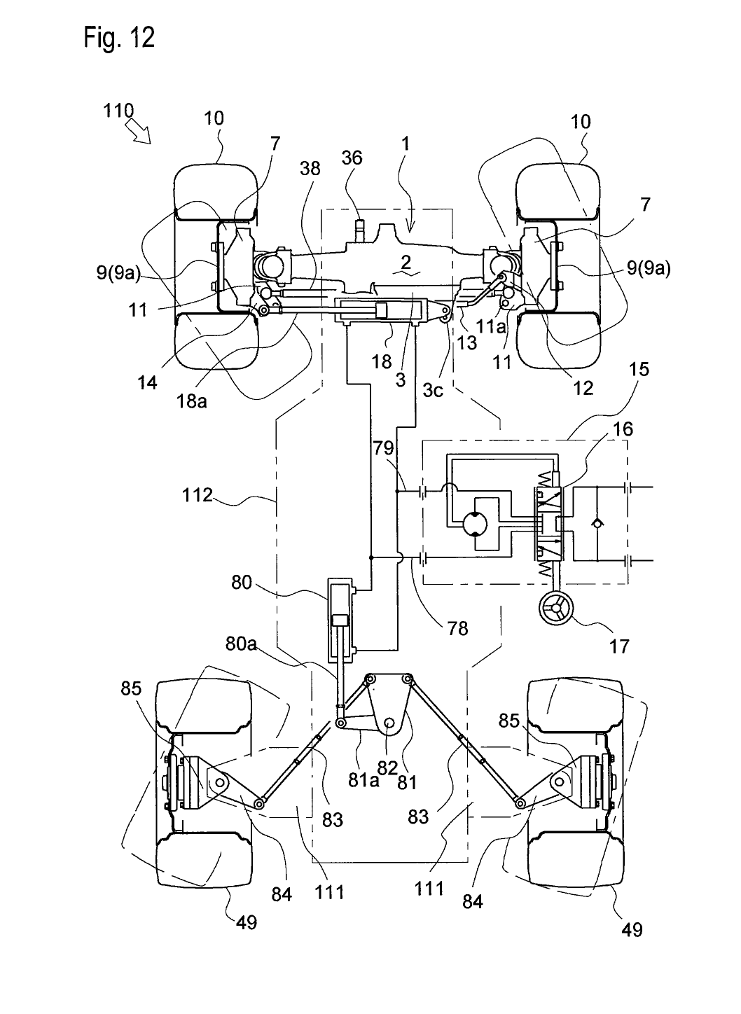

An entire structure of the transaxle 1 in respect of the present application will be described with reference to FIGS. 1-8. The transaxle 1 includes a main casing 2 as shown in FIGS. 1 and 2 or the like. A fore-and-aft horizontal penetrating center pin hole 2a is bored in an upper end of the lateral central portion of the main casing 2. The transaxle 1 is pivoted on a center pin passed though the center pin hole 2a, so that right and left end portions of the transaxle 1 are vertically swingable relative to a vehicle frame (e.g., a vehicle frame 102 of a vehicle 100 in FIG. 11 or a vehicle frame 112 of a vehicle 110 in FIG. 12 as mentioned later).

As shown in FIGS. 1 and 2, a fore-and-aft horizontal PTO shaft 36 is journalled by the main casing 2 in one of right and left sides of the center pin hole 2a (in the present embodiment, the left side). The PTO shaft 36 is projected outward back and forth from the main casing 2. In the other of right and left sides of the center pin hole 2a (in the present embodiment, the right side) in the main casing 2, a first hydraulic motor M1 and a second hydraulic motor M2 are juxtaposed right and left. Each of the hydraulic motors M1 and M2 is a variable displacement and axial-piston type hydraulic motor, and includes a corresponding lateral horizontal motor shaft 6. A duct plate 4 is fixed onto the inside of the main casing 2. The first hydraulic motor M1 is attached on the right side of the duct plate 4, and the second hydraulic motor M2 is attached on the left side of the duct plate 4.

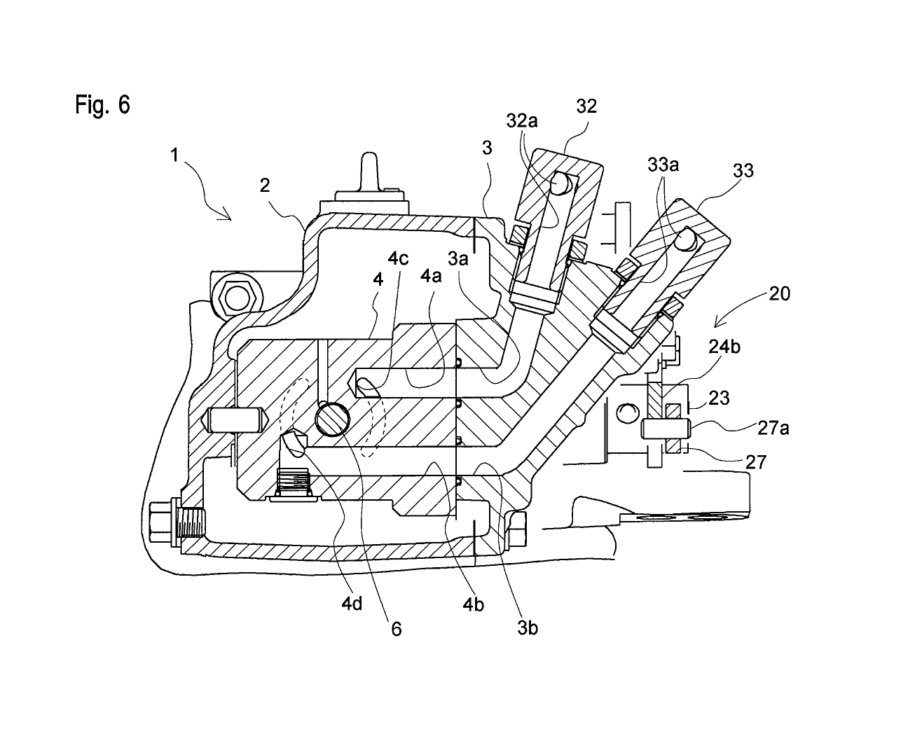

As shown in the FIG. 6, the duct plate 4 is bored with a pair of kidney ports 4c and 4d penetrating between the left and right surfaces thereof onto which the respective hydraulic motors M1 and M2 are attached. In the duct plate 4, a fluid passage 4a is extended to the outside from the kidney port 4c, and a fluid passage 4b is from the kidney port 4d. The fluid passages 4a and 4b are opened outward at the back side surface of the duct plate 4, so that the respective kidney ports 4c and 4d are adapted for connecting to a hydraulic pressure source such as a later-discussed hydraulic pump P. Thus, the oil supplied from one of the fluid passages 4a and 4b is distributed to both the hydraulic motors M1 and M2 though the corresponding kidney port 4c or 4d connected with this fluid passage 4a or 4b, and the oil discharged from both the hydraulic motors M1 and M2 is collected to the other fluid passage 4b or 4a through the other kidney port 4d or 4c, and is returned to the hydraulic pressure source. Therefore, the hydraulic motors M1 and M2 are fluidly connected in parallel to the hydraulic pressure source.

As shown in FIGS. 1-3 and 7, a pair of right and left swash plate guide plates 5 are fixed in the main casing 2 so as to have both the hydraulic motors M1 and M2 and the duct plate 4 therebetween. The right swash plate guide plate 5 slidably rotatably supports a movable swash plate M1a of the first hydraulic motor M1, and the left swash plate guide plate 5 slidably rotatably supports a movable swash plate M2a of the second hydraulic motor M2. The hydraulic motors M1 and M2 have respective horizontal motor shafts 6 disposed coaxially to each other. The motor shafts 6 are pivotally supported at inner ends thereof in the duct plate 4. Each of the motor shafts 6 penetrates the corresponding hydraulic motor M1 or M2, and penetrates the corresponding movable swash plate M1a or M2a freely rotatably. An outer end portion of each of the motor shafts 6 is journalled by the corresponding swash plate guide plate 5 through a bearing.

As shown in FIGS. 1 and 2, the outer end portion of the motor shaft 6 of each of the first and the second hydraulic motors M1 is projected laterally outward from the corresponding swash plate guide plate 5. As shown in FIG. 2, the outer end portion of the motor shaft 6 of the first hydraulic motor M1 is connected rotatably integrally with an extending shaft 34 coaxially through a coupling. On the other hand, the second hydraulic motor M2 is connected rotatably integrally with the extending shaft 34 coaxially through the coupling and a coaxial extending shaft 35. Due to interposing the extending shaft 35 between the hydraulic motor M2 and the extending shaft 34, a space is afforded in the main casing 2, and the above-mentioned PTO shaft 36 is journalled by a portion of the main casing 2 just above the extending shaft 35.

As shown in FIGS. 1 and 2, right and left steering casings 7 are provided on the respective right and left end portions of the main casing 2. The steering casing 7 includes a kingpin casing part 7a of which an upper portion is fixed onto each of the right and left end portions of the main casing 2, and includes a rotatable casing part 7b which is pivotally provided on a lower portion of the kingpin casing part 7a through a bearing, and includes an axle-support casing part 7c which is fixed onto an opened outer end portion of the rotatable casing part 7b.

As shown in FIG. 2, a propeller shaft 8 acting as a kingpin is supported pivotally in the kingpin casing part 7a. A bevel gear 8a is fixed onto an upper end of the propeller shaft 8, and meshes with a bevel gear 34a, which is fixed (or formed integrally) onto each of outer ends of the extending shafts 34. A lower end of the propeller shaft 8 projects downward from the lower end of the kingpin casing part 7a, and is journalled by the bottom of the rotatable casing part 7b. A bevel gear 8b is fixed on the lower end portion of the propeller shaft 8.

A substantially horizontal axle 9 is journalled at an inner end portion thereof by the rotatable casing part 7b, and is at an axially intermediate portion thereof journalled by the axle-support casing part 7c. The axle 9 is fixedly provided with a large diameter bevel gear 9b thereon between the portions thereof journalled by the rotatable casing part 7b and the axle-support casing part 7c, and the large diameter bevel gear 9b meshes with the bevel gear 8b on the bottom of the propeller shaft 8. A flange 9a is formed at the outer end of the axle 9 to be fixed to a rim portion of a wheel (a wheel 10 as mentioned later). As a result, the wheels, fixed onto the respective flanges 9a, are steerably supported by the transaxle 1 so as to be able to be driven by the hydraulic motors M1 and M2. In other words, the wheels are steerable wheels which are left-and-right rotatable by rotating the rotatable casing part 7b (and the axle-support casing part 7c) around the kingpin casing part 7a.

As shown in FIG. 1, in the back end portions of the rotatable casing parts 7b of the respective steering casings 7, tie rod stays 11 are formed so as to project backward. Each of the tie rod stays 11 is formed with a tie rod support portion 11a at a back portion thereof (that is distant from the steering casing 7), and is formed with a tie rod support portion 11b at a front portion thereof (that is near the steering casing 7). A distance between the left and right tie rod support portions 11b is longer than a distance between the left and right tie rod support portions 11a, because the tie rod stays 11 are extended so as to reduce the distance therebetween as they go backward.

In FIG. 1, for convenience, both a short rear tie rod 37 interposed between the tie rod support portions 11a of both the tie rod stays 11, and a long front tie rod 38 interposed between the tie rod support portions 11b of both the tie rod stays, are illustrated. However, actually, it is selected whether the tie rod 37 is interposed between the tie rod support portions 11a, or the tie rod 38 is interposed between the tie rod support portions 11b. When a large turning angle of the wheels on the axles 9 according to the steering wheel operation is required, the rear tie rod 37 is selected, and when a small turning angle of the wheels according to the steering wheel operation is required, the front tie rod 38 is selected.

As shown in FIG. 1, a power steering cylinder stay 14 projected backward is formed at the rotatable casing part 7b of one (left side) of the steering casings 7, and a power steering cylinder stay 3c projected backward is formed at a rear cover 3 as mentioned later. A tip of a piston rod of a power steering cylinder as mentioned later is able to be pivoted on the power steering cylinder stay 14, and a cylinder bottom of the power steering cylinder is able to be pivoted on the power steering cylinder stay 3c, respectively.

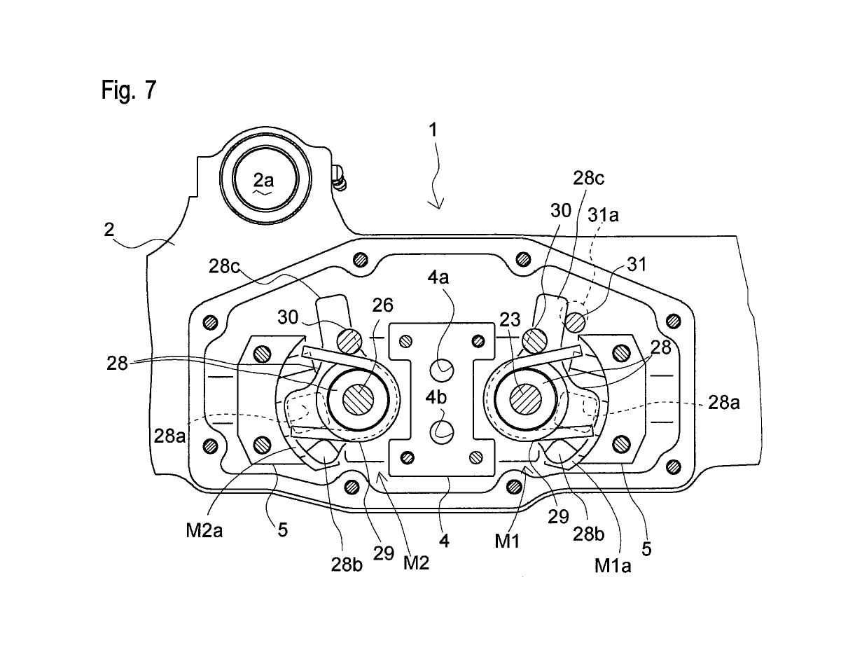

As shown in FIG. 7, a rear end of the portion of the main casing 2, incorporating both hydraulic motors M1 and M2, the duct plate 4 and both swash plate guide plates 5, is opened. As shown in FIGS. 1, 3, 6 and others, the main casing 2 is detachably fixedly provided on the rear end thereof with a rear cover 3 so as to cover the opening portion. When the rear cover 3 is removed from the main casing 2, both hydraulic motors M1 and M2, and the duct plate 4 or the like, can be accessed.

As shown in FIG. 6, oil passages 3a and 3b are bored in the rear cover 3, so as to be opened respectively to the fore-and-aft horizontal upper and lower oil passages 4a and 4b bored in the swash plate 4. The oil passage 3a opened to the upper oil passage 4a is bent upward, and a port member 32 is fitted into the upper end opening portion of the oil passage 3a. An outwardly opened port 32a is formed in the port member 32 and is opened to the oil passage 3a. The oil passage 3b opened to the lower oil passage 4b is bent upwardly rearward, and is opened rearwardly downward of the port member 32, and a port member 33 is fitted into the opening portion of the oil passage 3b. An outwardly opened port 33a is formed in the port member 33 so as to be opened to the oil passage 3b. Hydraulic pressure pipes are connected to the respective port members 32 and 33 so at to be opened to the respective ports 32a and 33a. As a result, oil circulates between the hydraulic pressure source and the ports 32a and 33a.

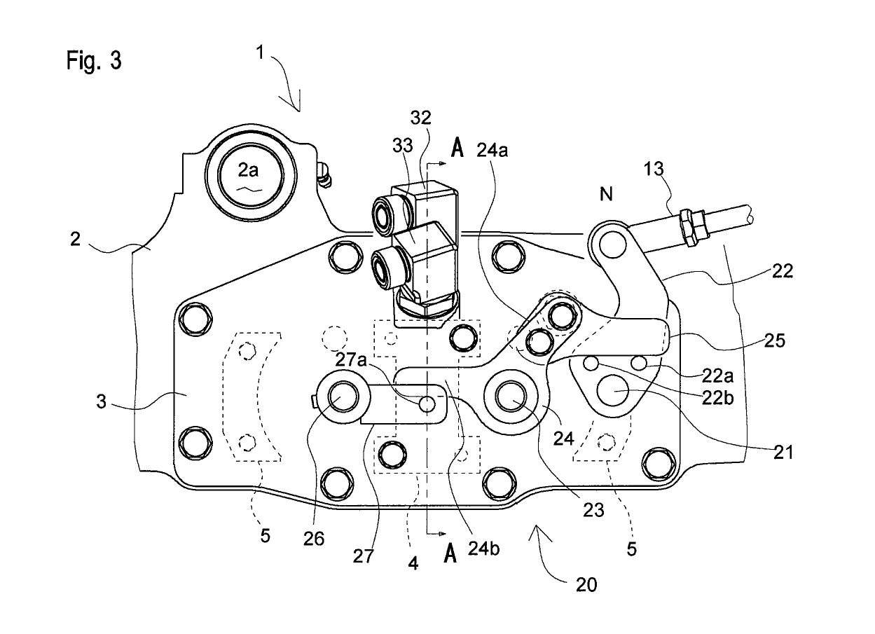

The rear cover 3 supports a motor control linkage 20 for synchronously tilting the movable swash plates M1a and M2a of both hydraulic motors M1 and M2 according to turning of the right and left steerable wheels supported by the transaxle 1. As shown in FIGS. 1 and 3 and others, the motor control linkage 20 includes three fore-and-aft horizontal rotary shafts pivoted on the rear cover 3, i.e., a pivot shaft 21, a motor control shaft (a first rotary shaft for controlling the movable swash plate of the first hydraulic motor) 23 and a motor control shaft (a second rotary shaft for controlling the movable swash plate of the second hydraulic motor) 26. In the lateral direction, the motor control shaft 26 is disposed on the left side of the motor control shaft 23, and the pivot shaft 21 is disposed on the right side of the motor control shaft 23 (in the opposite direction to the motor control shaft 26). Further, the motor control shafts 23 and 26 are disposed in the same height. The pivot shaft 21 is disposed in the substantially same height as both the shafts 23 and 26.

As shown in FIGS. 1 and 2, in the main casing 2, a pair of arms 28 are fixed on the inner ends of the respective motor control shafts 23 and 26. Each arm 28 is fitted onto each of the movable swash plate M1a and M2a, so as to tilt the corresponding movable swash plate M1a or M2a according to the rotation of the corresponding motor control shaft 23 or 26. In the concrete, as shown in FIG. 7, a projection 28a is formed on each of the arms 28. Each of the projections 28a is fitted into a channel formed on a side end of each of the movable swash plates M1a and M2a, so that each arm 28 is fitted onto the corresponding movable swash plate M1a or M2a.

Furthermore, as shown in FIG. 7, to be accurate, the figures of the arm 28 fitted onto the movable swash plate M1a and the arm 28 fitted onto the movable swash plate M2a are not the same, and are symmetrical as reversed to each other with respect to a vertical shaft when viewing in rear.

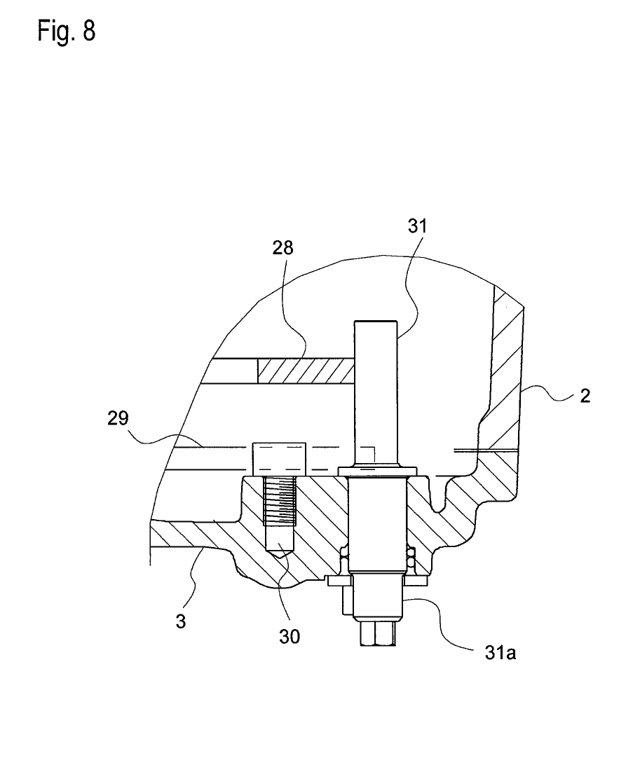

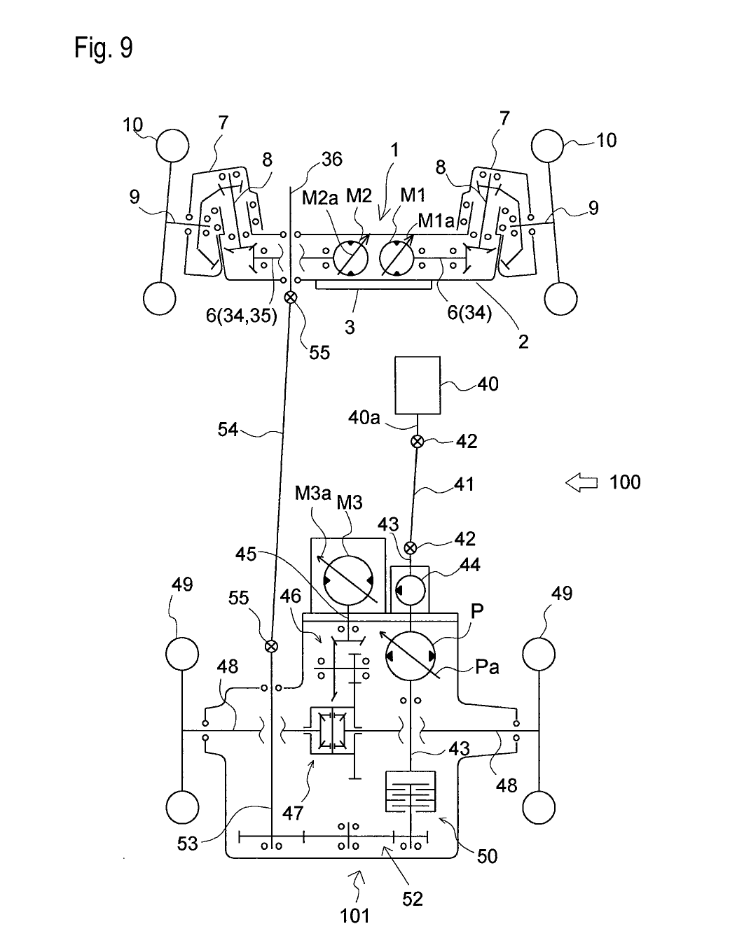

As shown in FIGS. 1 and 7, springs 29 for returning the arms 28 to respective initial positions are coiled on boss portions of the arms 28 provided on the respective motor control shafts 23 and 26. One end portions of both end portions of the respective springs 29 are pressed against respective contact portions 28b formed on the arms 28. As shown in FIGS. 7 and 8, a pair of left and right engaging pins 30 are planted into the rear cover 3. The other end portions of respective springs 29 are pressed against respective engaging pins 30. The one end portion of each spring 29 is pressed by the corresponding contact portion 28b according to the returning power of the springs 29 so as to move away from the other end portion engaged with the engaging pins 30. Essentially, the initial position of each arm 28 and the corresponding motor control shaft 23 or 26 is defined as their position when each of the springs 29 becomes an initial state, i.e., the position where the contact portion 28b is not able to be further pushed by the one end portion of the spring 29. As mentioned before, because the hydraulic motors M1 and M2 are fluidly connected in parallel to the hydraulic pressure source, the initial positions of both movable swash plates M1a and M2a defined by both motor control shafts 23 and 26 in the initial positions define an initial total capacity of the hydraulic motors M1 and M2 and the speed of axles 9 during straight traveling of a vehicle (to be accurate, in case where the transaxle 1 is applied to a vehicle 100 as mentioned later, the relative speed for axle 48 as shown in FIG. 9 and others).

The initial total capacity of the hydraulic motors M1a and M2a is adjusted so as to adjust the axle 9 (the relative speed for the axle 48) during straight traveling of the vehicle, and the only initial position of either the movable swash plate M1a or M2a is enough to be adjusted for adjusting the initial total capacity, because if the capacity difference of the hydraulic motors M1 and M2 occurs, most of hydraulic fluid is passed through a larger capacity motor of the hydraulic motors M1 and M2. As a result, driving force is distributed to the left and right axles 9 equally so as to equalize the rotary speeds of the axles 9.

In the transaxle 1, as shown in FIGS. 7 and 8, an initial position adjustment pin 31 is planted into the rear cover 3. The initial position adjustment pin 31 abuts against an initial position adjustment arm portion 28c formed on the arm 28 provided on the motor control shaft 23 for the first hydraulic motor M1. Therefore, the arm 28 fixed on the motor control shaft 23 can be retained at a position within a range where the contact portion 28b can be moved by the one end portion of the spring 29 (i.e., where the spring 29 keeps the force pushing the contact portion 28b). The engaging position of the initial position adjustment pin 31 with the spring 29 is an initial position of the motor control shaft 23 and the arm 28 fixed thereon. On the other hand, the arm 28 provided on the motor control shaft 26 for the second hydraulic motor M2 is not provided with such an initial position adjustment pin 31. Therefore, an inherent limit position of the contact portion 28b to be pushed by the one end portion of the spring 29 is defined as the initial position of the motor control shaft 26 and the arm 28.

As shown in FIGS. 7 and 8, a journal portion 31a is extended outwardly backward from the initial position adjustment pin 31, and the journal portion 31a is rotatably supported by the rear cover 3. The initial position adjustment pin 31 is an eccentric pin, and a centerline thereof is different from a centerline of the journal portion 31a. Normally, a nut is screwed on an outer end of the journal portion 31a projected outwardly backward from the rear cover 3, and the journal portion 31a is fastened to the rear cover 3 so as to fix the initial position adjustment pin 31. If the initial total capacity of the hydraulic motors M1 and M2 needs to be adjusted by adjusting the initial position of the movable swash plate M1a, the nut is unfastened and the initial adjustment pin 31 is rotated centered on the centerline of the journal portion. Therefore, the initial position of the arm 28 fixed on the motor control shaft 23, and defined by the initial position adjustment pin 31, can be adjusted.

Alternatively, the initial position adjustment pin 31 may be fixed on the arm 28 fixed on the motor control shaft 26 (not on the motor control shaft 23) according to the form change of the transaxle 1 adopting the motor control linkage 20. In order to react against such a form change, as shown in FIG. 7, the initial position adjustment arm portions 28c for abutting with the initial position adjustment pin 31 are formed on the arms 28 respectively fixed on the motor control shaft 23 and 26. That is to say, as mentioned above, figures of the left and right arms are symmetrical about a line.

Because of the structure of a later-discussed motor control linkage 20, according to turning of the steerable wheels supported by the steering casing 7 from the state that the steerable wheels are directed straight in the fore-and-aft direction, the motor control shaft 23 is synchronously rotated leftward (counterclockwise) and the motor control shaft 26 is synchronously rotated rightward (clockwise). According to the rotation of these motor control shafts 23 and 26, both arms 28 are rotated integrally with respective motor control shafts 23 and 26, and both movable swash plates M1a and M2a are tilted from the initial positions. Therefore, respective capacities of both hydraulic motors M1a and M2a are changed and the speed of the steerable wheels are changed according to the turning.

If the steerable wheels are required to be accelerated according to the turning thereof, a tilt angle of each of the movable swash plates M1a and M2a at the initial position (from a surface perpendicular to the motor shaft 6, i.e., from a vertical surface) is a maximum, i.e., the capacities of the hydraulic motors M1 and M2 are the maximum when a vehicle is directed straight in the fore-and-aft direction. In other words, according to the turning of the steerable wheels, the tilt angles of the movable swash plates M1a and M2a are decreased, i.e., the capacities of the hydraulic motors M1 and M2 are decreased. If the steering wheels are required to be decelerated according to the turning thereof, the tilt angle of each of the movable swash plates M1a and M2a at the initial position is a minimum, i.e., the capacities of the hydraulic motors are the minimum when a vehicle is directed straight in the fore-and-aft direction. In other words, according to the turning of the steerable wheels, the tilt angles of the movable swash plates M1 and M2 are increased, i.e., the capacities of the hydraulic motors M1 and M2 are increased.

As shown in FIG. 2, both movable swash plates M1a and M2a are disposed and tilted on an axis symmetrically with respect to the duct plate 4, when viewing in rear, in order to achieve the rotations of the motor control shafts 23 and 26 and the tilts of the movable swash plates M1a and M2a according to the turning of the steerable wheels as mentioned above. But, as a result of the initial position adjustment of the motor control shaft 23 by the above-mentioned initial position adjustment pin 31, both initial positions of the movable swash plates M1a and M2a are occasionally changed slightly.

According to the above-mentioned rotations of both motor control shafts 23, 26 and the arms 28 by the turning of the steerable wheels, the contact portion 28b pushes one end of the spring 29 toward the other end of the spring 29 retained by the engaging pin 30. Therefore, the biasing force for returning to the initial position is afforded to the spring 29. As the steering wheel is returned to the straight traveling position, the hydraulic motors M1 and M2 are rapidly returned to the initial positions. The speed of the steerable wheels is returned to the initial straight traveling speed of a vehicle.

Referring to FIGS. 1, 3-5 and others, in the motor control linkage 20 behind the rear cover 3, a linkage from one of the steering casings 7 to both motor control shafts 23 and 26 will be described. As shown in FIG. 1, a link stay 12 is fixed on the rotatable casing part 7b of the right-hand steering casing 7, which is near to the first hydraulic motor M1, (i.e., which is laterally opposite to the rotatable casing part 7b of the steering casing 7 provided with the power steering cylinder stay 14). One end of a link rod 13 is pivoted on the link stay 12.

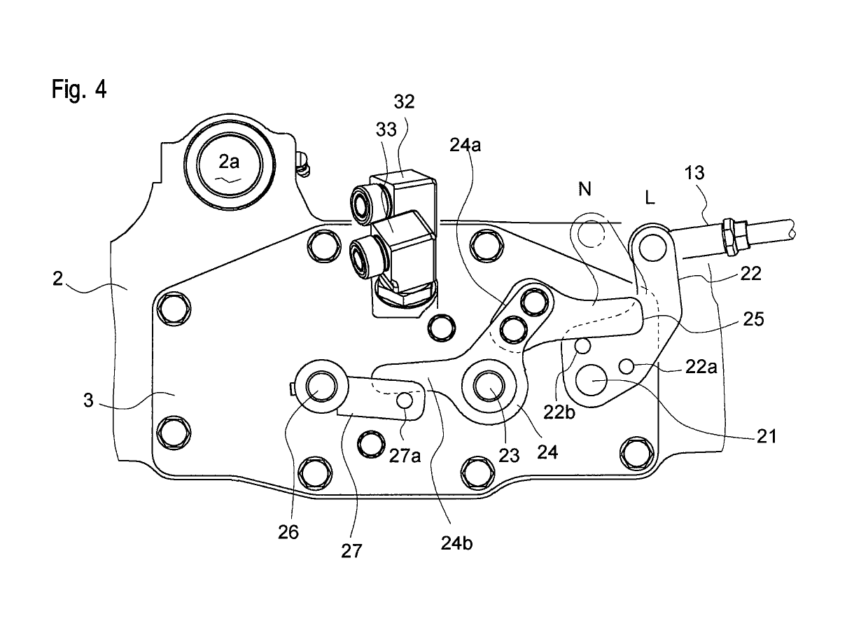

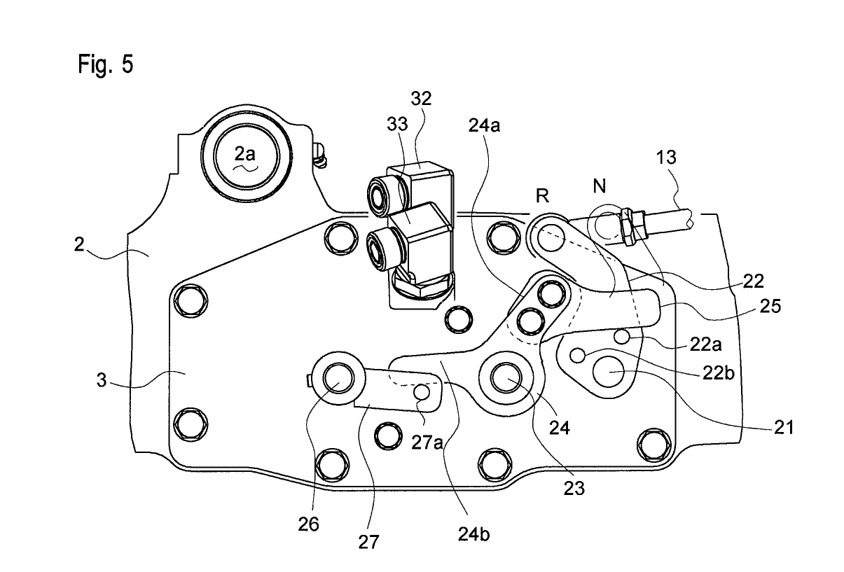

As shown in FIG. 3 and others, the above-mentioned pivot shaft 21 is relatively rotatably supported by rear cover 3 at a right side of the motor control shaft 23, and a first arm 22 is fixedly provided on the pivot shaft 21, and the other end of the link rod 13 is pivoted on the tip (the upper end) of the first arm 22. When the vehicle is directed straight in the fore-and-aft direction, the first arm 22 is disposed in the straight traveling position N as shown in FIG. 3. When the vehicle is directed to the left, the rotatable casing part 7b of the right steering casing 7 is rotated so as to swing the rear end thereof rightward, thereby pulling the link rod 13 rightward. Therefore, as shown in FIG. 4, the first arm 22 is rotated rightward from the straight traveling position N to the left turn position L. When the vehicle is directed to the right, the rear end of the rotatable casing part 7b of the right steering casing 7 is swung leftward so as to thrust the link rod 13 leftward, whereby the first arm 22 is rotated leftward from the straight traveling position N to the right turn position R as shown in FIG. 5.

A pair of left and right horizontal push-up pins 22a and 22b are projected backward from a portion of the first arm 22 just above the pivot shaft 21. As shown in FIG. 3, when the first arm 22 is in the straight position N, the left and right push-up pins 22a and 22b are aligned to the same height. As shown in FIG. 4, when the first arm 22 is in the left turn position L, the left push-up pin 22b is higher than the right push-up pin 22a. As shown in FIG. 5, when the first arm 22 is in the right position R, the right push-pin 22a is higher than the left push-up pin 22b.

Furthermore, in order to accurately position both the push-up pins 22a and 22b to the same height when the steerable wheels supported by the respective steering casings 7 are directed for straight traveling of the vehicle, i.e., in order to set the first arm 21 to the straight traveling position N shown in FIG. 3, the link rod 13 may be configured to have an adjustable variable length, for instance.

As shown in FIGS. 3-5, behind the rear cover 3, an arm member 24 is fixed on the motor control shaft 23 fitted onto the movable swash plate M1a of the first hydraulic motor, and the arm member 24 is integrally formed with a second arm 24a extended rightward and a third arm 24b extended leftward. The press arm 25 is fastened to the second arm 24a by a bolt.

In the transaxle 1, the initial position of the motor control shaft 23 is adjusted by the above-mentioned initial position adjustment pin 31. Alternatively, a hole for passing a bolt, formed on the second arm 24a or the press arm 25, may be a long hole or the like so that the position of the press arm 25 to be fastened to the second arm 24a is able to be adjusted, thereby enabling the adjustment of the initial position of the motor control shaft 23. In other words, as result of the use of the initial position adjustment pin 31, the position adjustment between the second arm 24a of the arm member 24 and the press arm 25 is not required to be strict. Consequently, labors for the position adjustment therebetween can be reduced, and the required accuracy of processing can be reduced.

As shown in FIG. 3, when the first arm 22 is in the straight traveling position N, the press arm 25 is put on both push-up pins 22a and 22b, which are aligned to the same height as mentioned above. As shown in FIG. 4, as the first arm 22 rotates from the straight traveling position N to the left turn position L, the left push-up pin 2b is moved upward, and pushes up the press arm 25. Consequently, the second arm 24a is rotated leftward and the third arm 24b rotatably integral with the second arm 24a is moved downward. On the other hand, as shown in FIG. 5, as the first arm 22 rotates from the straight traveling position N to the right turn position R, the right press pin 22a is moved upward, and pushes up the press arm 25. Consequently, the second arm 24a is rotated leftward and the third arm 24b rotatably integral with the second arm 24a is moved downward. Thus, whether the rotatable casing portion 7b of the steering casing 7 is turned leftward or rightward, the arm member 24 and the motor control shaft 23 are rotated in the same direction (leftward (counterclockwise)) by the same amount.

As shown in FIGS. 3-5, behind the rear cover 3, a fourth arm 27 extending rightward is fixed on the motor control shaft 26 fitted onto the movable swash plate M2a of the second hydraulic motor M2, and a press pin 27a is horizontally extended from the fourth arm 27. The press pin 27a is put on the third arm 24b of the arm member 24. Furthermore, the fourth arm 27 is biased upward by the spring 29 provided on the motor control shaft 26 so as to retain the press pin 27a thereby constantly abutting against the third arm 24b.

As mentioned above, whether the vehicle is directed to the left or to the right, the third arm 24b of the arm member 24 is rotated downward according to increase of the turn angle of the steerable wheels, as shown in FIGS. 4 and 5, so as to rotate the fourth arm 27 downward through the press pin 27a and rotate the motor control shaft 26 integrally with the fourth arm 27 rightward (clockwise). Hence, as mentioned above, the third arm 24 synchronously rotates the motor control shaft 23 leftward (counterclockwise) and the control shaft 26 rightward (clockwise), whether the steerable wheels are turned to the right or to the left.

A four-wheel driving vehicle 100 which adopts the transaxle 1 composed as mentioned above for driving the front wheels will be described with reference to FIGS. 9-11. As shown in FIGS. 9-11, the vehicle 100 is provided with a rear transaxle 101 for the driving of rear wheels 49 and the front transaxle 1 for the driving of front wheels 10. The front wheels 10 are the steerable wheels fixed on the outer end of the axle 9 supported by the steering casings 7 which are attached on the left and right respective ends of the front transaxles 1 as mentioned above.

As shown in FIG. 9, the rear transaxle 101 incorporates a hydraulic pump P, and is provided on the front end portion thereof with a charge pump 44 and a hydraulic motor M3. A pump shaft 43 of the pump P also serves as a driving shaft of the charge pump 44, projects forward, and is interlockingly connected to an output shaft 40a of an engine 40 through a propeller shaft 41 and universal joints 42.

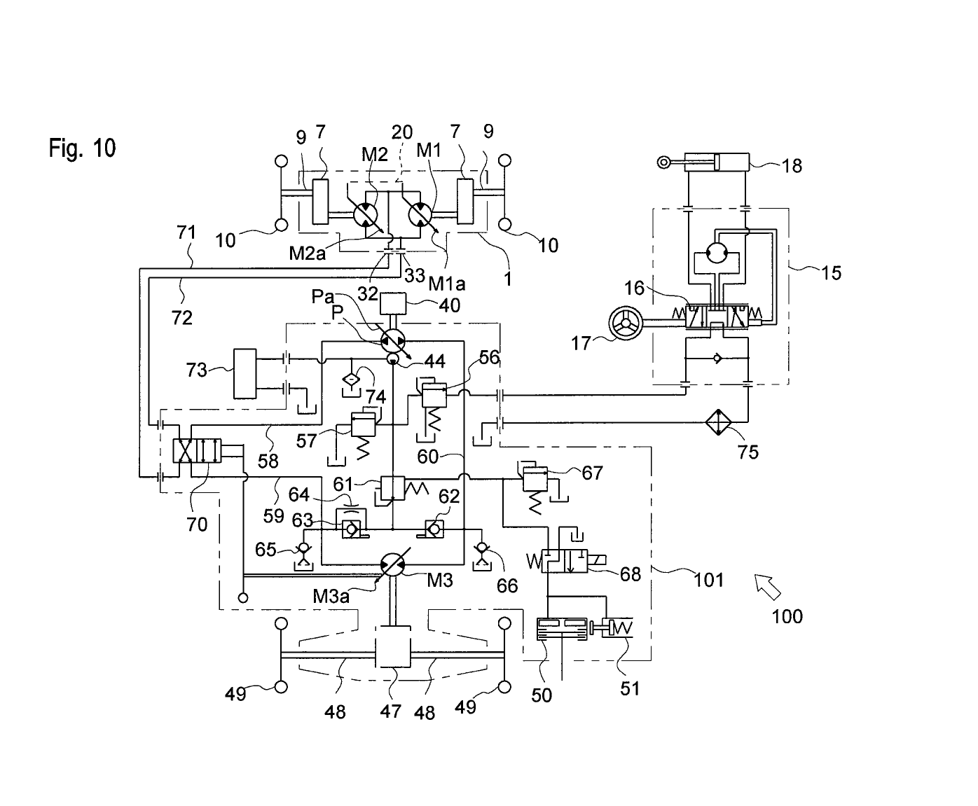

The hydraulic motor M3 is supplied with the oil from the hydraulic pump P according to a later-discussed hydraulic circuit structure as shown in FIG. 10. The motor shaft 45 is interlockingly connected to a differential rotation assembly 47 differentially rotatably connecting the left and right both rear shafts 48 through a deceleration gear train. Rear axles 48 project from the respective left and right side ends of the rear transaxle 101, and are provided with the respective rear wheels at the outside ends thereof.

Furthermore, as shown in FIG. 9, in the rear transaxle 101, the pump shaft 43 of the hydraulic pump P is extended, and is interlockingly connected through a PTO clutch 50 and a deceleration gear train 52 to a PTO shaft 53 journalled by the rear transaxle 101. The PTO shaft 53 is drivingly connected through a propeller shaft 54 and universal joints 55 to the above-mentioned PTO shaft 36 journalled by the front transaxle 1. Consequently, the rotary speed of the PTO shaft 36 is controlled due to the rotary speed control of the engine 40.

As shown in FIG. 9, movable swash plates Pa and M3a are provided on the hydraulic pump P and hydraulic motor M3, respectively. The movable swash plate Pa of the hydraulic motor Pa is interlocked with a main speed changing manipulator, such as a pedal or a lever, provided on the vehicle 1, and the fluid delivery direction and the fluid delivery amount of the hydraulic pump P are decided according to the decision of the tilt direction and tilt angle of the movable swash plate Pa, thereby deciding the rotary direction and the rotary speed of the hydraulic motors M1 and M2 in the front transaxle 1 and the hydraulic motor 3, respectively.

The movable swash plate M3a of the hydraulic motor M3 is interlocked with an auxiliary speed changing manipulator, such as a pedal or a lever, provided on the vehicle 1 so as to change over the tilt angle of the movable swash plate M3a between an initial displacement setting position and a special displacement setting position. Therefore, the rotary speed level of the motor shaft 45 can be selected between high and low levels. Alternatively, more than two special displacement setting positions may be established so as to enable setting of more than two speed levels. The initial displacement setting position may be the large displacement (low speed) position and the auxiliary displacement setting position may be the small displacement (high speed) position. Oppositely, the initial displacement setting position may be the small displacement (high speed) position and the auxiliary displacement setting position may be the large displacement (low speed) position.

As mentioned above, according to the left and right turning of the front steerable wheels 10 by the motor control linkage 20, the movable swash plates M1a and M2a of the hydraulic motors M1 and M2 in the front transaxle 1 are tilted from the initial position to the tilt position in response to the turning angle of the front wheels 10. Therefore, the speed of the front wheels 10 is changed according to the turning radius so as to prevent the drag of either the front wheels 10 or the rear wheels 49 in the turning of the vehicle.

If the front transaxle 1 is configured so as to accelerate the steerable wheels 10 as the turning angle thereof becomes larger (i.e., as the turning radius thereof becomes smaller), the initial displacement setting position is defined as a maximum displacement setting position. As the turning angle of the steerable wheels 10 become larger, the hydraulic motors M1 and M2 are controlled so as to decrease the displacement thereof. If the front transaxle 1 is configured so as to decelerate the steerable wheels 10 as the turning angle thereof become larger, the initial displacement position is defined as a minimum displacement setting position. As the turning angle of the steerable wheels 10 become larger, the hydraulic motors M1 and M2 are controlled so as to increase the displacement thereof.

Alternatively, the movable swash plates M1a and M2a may be interlocked with the movable swash plate M3a. However, as mentioned later, the hydraulic motor M3 and the pair of hydraulic motors M1 and M2 are fluidly connected in series to the hydraulic pump P. When the hydraulic motor M3 is on the upstream side of the hydraulic motors M1 and M2 in the fluid delivery direction from the hydraulic pump P, the tilt control of the swash plate M3a is reflected in the fluid delivery pressure of the hydraulic motor M3. In this case, even if the swash plates M1a and M2a are not connected to the swash plate M3a, the speed of the front wheels 10 also can be changed synchronously to the speed change of the rear wheels 49 based on the swash plate control of the hydraulic motor M3.

A hydraulic circuit structure of the vehicle 100 shown in FIG. 10 will be described. A driving-setting switching valve 70 is incorporated in the rear transaxle 101. An oil passage 58 is interposed between one of the suction or delivery ports of the hydraulic pump P and the driving-setting switching valve 70, an oil passage 59 is interposed between one of the suction or delivery ports of the hydraulic motor M3 and the driving-setting switching valve 70, and an oil passage 60 is interposed between the other of the suction or delivery ports of the hydraulic pump P and the other of the suction or delivery ports of the hydraulic motor M3.

Pipes or the like constitute oil passages 71 and 72 interposed between the rear transaxle 101 and the front transaxle 1. The oil passages 71 and 72 are connected to the driving-setting switching valve 70 in the rear transaxle 101 and also are respectively connected to port members 32 and 33 (ports 32a and 33a) of the front transaxle 1. One of the suction or delivery ports (kidney port 4c) of each of the hydraulic motors M1 and M2 is connected to the oil passage 71 and the other suction or delivery port (kidney port 4d) of each of the hydraulic motors M1 and M2 is connected to the oil passage 72 so as to constitute the parallel circuit of the hydraulic motors M2 and M3. Alternatively, the connecting relation of the port members 32 and 33 to the oil passages 71 and 72 can be reversed.

The driving-setting switching valve 70 is switched between a four-wheel driving position and a two-wheel driving position. FIG. 10 illustrates the driving-setting switching valve 70 set at the four-wheel driving position. In this case, the oil passages 59 and 72 are connected to each other, and the oil passages 58 and 71 are connected to each other, so as to constitute a HST closed circuit fluidly connecting the pair of hydraulic motors M1 and M2 in series to the hydraulic pump P. If the movable swash plate Pa of the hydraulic pump P is disposed in the tilt direction for forward traveling of vehicle, the delivery fluid of the hydraulic pump P flows through the oil passage 60, the hydraulic motor M3, the oil passage 59, the driving-setting switching valve 70, the oil passage 72, both of the hydraulic motors M1 and M2, the oil passage 71, the driving-setting switching valve 70 and the oil passage 58 in turn, and returns to the hydraulic pump P. In other words, in the flowing of the delivery fluid of the hydraulic pump P, the hydraulic motor M3 is upstream of the hydraulic motors M1 and M2.

If the driving-setting switching valve 70 is disposed at the two-wheel driving position, the oil passages 58 and 59 are connected to each other through the driving-setting switching valve 70, and the HST closed circuit is constituted between the hydraulic pump P and the hydraulic motor M3. The oil passages 71 and 72 are separated from the oil passages 58 and 59, respectively, and are connected to each other through the driving-setting switching valve 70 so that the delivery fluid from the hydraulic motor P is not supplied with the hydraulic motors M1 and M2. However, the hydraulic motors M1 and M2 can be rotated freely by the rotation of the front wheels 10 following the rear wheels 49 driven by the hydraulic motor M3, and a dynamic brake from the hydraulic motors M1 and M2 to the front wheels 10 is prevented.

The hydraulic pressure supply structure to the HST closed circuit and the other hydraulic instruments will be described. The charge pump 44 sucks oil from a fluid sump in a casing of the rear transaxle 101 through a filter 74, and from an external reservoir tank 73, and supplies the oil to the HST closed circuit through a pressure reducing valve 56, a pressure regulation valve 57, a resisting valve 61 and one of charge check valves 62 and 63, wherein the charge check valve 62 is connected to the oil passage 60 which is pressurized higher during forward traveling, and the charge check valve 63 is connected to the oil passage 59 which is pressurized higher during backward traveling. An orifice 64 is provided for bypassing the charge check valve 63 so as to expand the neutral area of the hydraulic pump P.

Furthermore, to replenish the oil leaked from the HST closed circuit when the vehicle is parked on a slope or for another reason, check valves 66 and 65, which are defined as check valves having the ability to supply the oil from the fluid sump in the casing of the rear transaxle 101, are connected to the respective oil passages 60 and 59.

The relief oil of the pressure reducing valve 56 is taken out from the rear transaxle 101, and is supplied to a power steering hydraulic cylinder 18 connected to the rotatable casing portion 7b of one of the steering casings 7 of the front transaxle 1 through a power steering valve 16 in a power steering hydraulic unit 15. The power steering valve 16 is interlocked with a steering wheel 17 defined as a steering operation device provided on the vehicle 100, and is switched by the motion of the steering wheel 17 so as to move the power steering cylinder 18 leftward or rightward turning the rotatable casing portions 7b of the steering casings 7 supporting the front wheels 10. The returned oil from the power steering valve 16 is returned to the fluid sump in the rear transaxle 101 through a line filter 75.

In the rear transaxle 101, the relief oil from the resisting valve 61 is regulated in pressure by the pressure regulation valve 67, and then is supplied to a PTO clutch switching valve 68 defined as an electromagnetic control hydraulic valve. The PTO clutch switching valve 68 is switched between the clutch-off position and the clutch-on position. FIG. 10 shows the PTO clutch switching valve 68 in the clutch-off position when the valve 68 is not energized. At this time, the oil is drained from the PTO clutch 50 and a PTO brake 51, so that the PTO clutch 50 is disengaged, and simultaneously, the PTO brake 51 brakes the transmission downstream side portion thereof so as to prevent the inertial rotation of the PTO shafts 52 and 36. When the PTO clutch switching valve 68 is energized and is switched to the clutch-on position, the valve 68 supplies the oil from the resisting valve 61 to a clutch-operation hydraulic chamber of the PTO clutch 50 so as to engage the PTO clutch, thereby transmitting the engine power to the PTO shafts 53 and 36. At the same time, the oil is supplied to the PTO brake 51 so that the PTO brake 51 is separated from the transmission downstream side portion thereof so as to relieve the PTO shafts 53 and 36 from the braking force.

Regarding to the rear transaxle 101 as mentioned above with reference to FIGS. 9 and 10, the casing structure of the rear transaxle 101 will be described with reference to FIG. 11. A main casing 101a incorporates the hydraulic pump P as shown in FIG. 9, the traveling drive train from the motor shaft 45 through the deceleration gear train 46 to the differential rotation assembly 47 and the PTO drive train from the PTO clutch 50 through the PTO deceleration gear train 52 to the PTO shaft 53. The main casing 101a is fixedly provided at the left and right ends thereof on respect axle casings 101b extended laterally outwardly and the axle casings 101b are fixed to a vehicle frame 102. Each of the axle casings 101b incorporates and supports the corresponding shaft 48 so that the rear wheels 49 are fixed on the outer ends of the axles 48 extending from the outer ends of respective axle casings 101b.

A front casing 101c extended forward from the main casing 101a incorporates either the charge pump 44 or the hydraulic motor M3. Another casing (not shown) is extended forward from the main casing 101a in parallel to the front casing 101c so as to incorporate the other of the charge pump 44 or the hydraulic motor M3.

The front casing 101c is fixedly provided with a valve casing 101d further extended forward from the front end thereof. The driving-setting switching valve 70 is incorporated in the valve casing 101d, and the pressure fluid pipes 71 and 72 (the oil passages 71 and 72 as shown in FIG. 10) connected to the driving-setting switching valve 70 are extended from the valve casing 101d so as to connect to the above-mentioned port members 32 and 33 of the front transaxle 1.

As shown in FIG. 11, an attachment structure of the power steering hydraulic cylinder 18 to the front transaxle 1 will be explained. On the power steering cylinder stay 3c formed on the rear cover 3, a cylinder bottom of the power steering hydraulic cylinder 18 is pivoted, and on the power steering cylinder stay 14 formed on the rotatable casing portion 7b of one (left) of the steerable casings 7, a tip of a piston rod 18a is pivoted. Thus, the power steering hydraulic cylinder 18 is substantially laterally horizontally extended in substantially parallel to the tie rod 37 and above the tie rod 37, wherein the tie rod 37 is interposed between the left and right tie rod stays 11 along the rear end of the transaxle 1. The power steering cylinder 18 is a double-acting cylinder, and has the oil chambers on both sides of a piston thereof, and the pressure fluid pipes 19a and 19b are extended from ports opened to the respective oil chambers and are connected to the power steering valves 16.

An embodiment of application of the transaxle 1 to a vehicle 110, as shown in FIG. 12, having the structure in which the rear wheels 49 supported by the rear transaxle 101 are defined as the steerable wheels, will now be described in comparison with the transaxle 1 in FIG. 11. The rear transaxle 101 in the vehicle 110 includes a pair of left and right output shaft casings 111 (instead of the axle casings 101b) fixedly supported by a vehicle frame 112 so as to respectively journal output shafts transmitting the power from the differential rotation assembly 47 to respective rear wheels 49. Each of the output shaft casings 111 is pivoted at the outer end thereof on each of knuckle arms 85 supporting the rear wheels 49 so that the knuckle arms 85 are freely turned laterally relative to the output casings 111.

A sector arm 81 is pivoted at a corner portion thereof, defined as a pivotal portion of the sector-shape, on the vehicle frame 112 through a pivot shaft 82. A pair of link rods 83 each is pivoted at one end thereof on each of left and right corner portions of the sector arm 81 other than the above-mentioned corner portion defined as the pivotal portion connected to the pivot shaft 82. The link rods 83 are pivoted at the other ends thereof on arms 84 extended from the knuckle arms 85 pivoted on the output shaft casings 111, respectively. Thus, the sector arm 81 is laterally rotated with respect to the pivot shaft 82 so as to laterally turn the rear wheels 49. Thus, the rear wheels 49 are defined as the steerable wheels.

An arm 81a rotatably integral with the sector arm 81 is extended from the pivot shaft 82 of the sector arm 81, and a tip of a piston rod 80a of a power steering cylinder 80 for the rear wheels is pivoted on the arm 81a. Oil passages 78 and 79 are extended from the power steering valve 16 in the power steering hydraulic unit 15, and each of them is bifurcated so as to connect to the respective oil chambers of each of the power steering cylinders 18 and 80. Thus, according to the operation of the steering wheel 17, the pair of front wheels 10 and the pair of rear wheels 49 are turned synchronously and laterally opposite to each other. For example, when the front wheels 10 are turned leftward, the rear wheels 49 are turned rightward.

The transaxle 1 in the vehicle 100 as shown in FIG. 11 will be compared with the transaxle 1 in the vehicle 110 as shown in FIG. 12. In the transaxle 1 of the vehicle 100 as shown in FIG. 11, the short tie rod 37 is interposed between the tie rod support portions 11a formed on the rear portions of the tie rod stays 11 of both of the left and right steerable casings 7. In the transaxle 1 of the vehicle 110 as shown in FIG. 12, the long tie rod 38 is interposed between the tie rod support portions 11b formed on the front portions of the tie rod stays 11.

In the vehicle 100 as shown in FIG. 11, the tie rod 37 between the tie rod support portions 11a is selected because the rear wheels 49 are the unsteerable wheels so that the front wheels 10 defined as the steerable wheels are required to increase the turning angle thereof relative to the operation degree of the steering wheel 17. On the other hand, in the vehicle 100 as shown in FIG. 12, the tie rod 38 between the tie rod support portions 11b is selected because both the front wheels 10 and the rear wheels 49 are the steerable wheels so that the front and rear wheels 10 and 49 are synchronously turned as mentioned above according to the operation of the steering wheel 17 so as to keep the small turning angle of the front wheel 10 relative to the operation degree of the steering wheel 17.

It is further understood by those skilled in the art that the foregoing description is a preferred embodiment of the disclosed device and that various changes and modifications may be made in the invention without departing from the scope thereof defined by the following claims.

What is claimed is:

1. A transaxle comprising:
a pair of left and right steerable wheels;
a hydraulic pressure source;
a pair of left and right variable displacement hydraulic motors, serving as first and second hydraulic motors for driving the respective steerable wheels, wherein the first and second hydraulic motors are fluidly connected in parallel to the hydraulic pressure source, and wherein the first and second hydraulic motors are provided with respective movable swash plates; and
a motor control linkage for simultaneously moving both the swash plates of the first and second hydraulic motors according to a turning angle of one of the steerable wheels, the motor control linkage including
a first pivot shaft for controlling the swash plate of the first hydraulic motor,
a second pivot shaft for controlling the swash plate of the second hydraulic motor,
a first arm pivoted on a side of the first pivot shaft opposite to the second pivot shaft so as to be linked to the one of the steerable wheels,
a second arm provided on the first pivot shaft so as to be linked to the first arm,
a third arm provided on the first pivot shaft rotatably integrally with the second arm, and
a fourth arm provided on the second pivot shaft, the fourth arm including a first contact portion, wherein, when the first arm rotates according to turning of the steerable wheel, the second and third arms rotate from initial positions of the second and third arms, so that the fourth arm, contacting the third arm at the first contact portion, rotates from an initial position of the fourth arm.

2. The transaxle according to claim 1, further comprising:
an initial position adjusting means provided to one of the first and second pivot shaft so as to adjust the corresponding first or second pivot shaft.

3. The transaxle according to claim 2, wherein the first arm includes a pair of second and third contact portions at which the first arm contacts the second arm, wherein the second arm contacts both the second and third contact portions of the first arm when the second arm is disposed at the initial position of the second arm, and wherein, when the one of the steerable wheels turns left or right, the second arm is pushed by one of the second and third contact portions of the first arm so that the rotatable direction of the second arm from the initial position of the second arm and the rotatable direction of the third arm from the initial position of the third arm are constant regardless of whether the one of the steerable wheels turns left or right.

4. The transaxle according to claim 3, further comprising:
an initial position adjusting means provided to one of the first and second pivot shaft so as to adjust the corresponding first or second pivot shaft.
